(19) United States
(12) Patent Application Publication
(10) Pub. No.: US 2005/0276467 A1
(43) Pub. Date: Dec. 15, 2005

(54) Apparatus for real-time monitoring of a workpiece

(75) Inventor: Ga-Lane Chen, Fullerton, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry Co., Ltd., Tu-Cheng City (TW)

(21) Appl. No.: 11/141,069

(22) Filed: May 31, 2005

(30) Foreign Application Priority Data
Jun. 11, 2004 (CN) 200410027655.4

(51) Int. Cl. G06K 9/00

(52) U.S. Cl. 382/152

(57) ABSTRACT

An apparatus for real-time monitoring of a workpiece (40) includes a laser diode (12) emitting a light irradiating the workpiece, a digital camera module (20) imaging the workpiece and forming an optical image signal, and a signal processing unit (30) electrically connected with the laser diode and the digital camera module respectively The optical image signal is transformed by the digital camera module into an electrical image signal, which is transmitted to the signal processing unit. The signal processing unit processes and analyzes the electrical image signal to determine whether there are any defects or flaws in the workpiece. By employing the digital camera module, the volume of the apparatus is reduced. In addition, the monitoring efficiency is improved because of the application of a laser diode. Furthermore, the digital camera module adopts aspheric lenses for improved quality imaging of the workpiece.

### FIELD OF THE INVENTION

The present invention relates to apparatuses for real-time monitoring of workpieces such as those on a production line, and particularly to an apparatus with a digital camera module for real-time monitoring of workpieces.

### BACKGROUND OF THE INVENTION

During processes such as precision machining, surface treatment, electronic packaging and semi-conductor manufacturing, it is generally necessary to monitor a workpiece in real time in order to timely determine whether there are any defects or flaws in the workpiece. This helps ensure timely troubleshooting of production problems that may arise, and a high yield rate of final products.

Conventionally, an apparatus for detecting machined workpieces includes a light emitting module, and a CCD (Charge Coupled Device) video which photographs the workpiece and forms an optical image signal. The optical image signal picked up by the CCD video is then transformed into a digital image signal. The digital image signal is then transmitted to a computer of the apparatus. The computer analyzes the digital image signal and determines whether the workpiece has a problem such as unsatisfactory surface smoothness, scratching, and so on. If any problem is detected, the computer displays a warning signal to an operator, and at the same time directs that all defective workpieces be marked. Accordingly, quality control personnel and engineers can deal with the defective workpieces as well as the cause of the problem.

Generally, the quality of the image picked up by the CCD video depends not only upon the resolution of the CCD video, but also upon the imaging position of the CCD video and the correct angle between the CCD video and the light emitting module. However, because the CCD video and the light emitting module are generally contained in the one same housing, it is problematic to adjust the CCD video and the light emitting module according to workpieces with different surface properties. In such circumstances, it is difficult to optimize the detecting capability of the apparatus in order to attain high quality images of workpieces. In addition, the optimized position of the CCD video and the reflecting angle of the light emitting module cannot generally be adjusted timely. Therefore the efficacy of the apparatus is limited to some extent.

Furthermore, the overall volume of space occupied by the apparatus is large. Moreover, when a CCD video picks up a stationary workpiece, it does not necessarily provide better image quality.

What is needed, therefore, is an apparatus with a digital camera module for real-time monitoring of workpieces, in which the apparatus readily, accurately and conveniently performs detecting of defects of workpieces.

### SUMMARY

An apparatus is provided for real-time monitoring of a workpiece. In a preferred embodiment, the apparatus comprises a laser diode emitting a light irradiating the workpiece, a digital camera module imaging the workpiece and forming an image signal, and a signal processing unit electrically connected with the laser diode and the digital camera module respectively. The optical image signal is transformed by the digital camera module into an electrical image signal, and the electrical image signal is transmitted to the signal processing unit. The signal processing unit processes and analyzes the electrical image signal to determine whether there are any defects or flaws in the workpiece.

A main advantage of the invention is that the volume of the apparatus is reduced because a conventional CCD video is replaced by a digital camera module. Accordingly, the space required in an application such as a production line is reduced. In addition, the monitoring efficiency is improved because of the application of a laser diode. Furthermore, the digital camera module adopts aspheric lenses. Therefore the quality of imaging of the workpiece is improved, which improves the quality of monitoring.

Other objects, advantages and novel features of the preferred and other embodiments will become more apparent from the following detailed description when taken in conjunction with the accompanying drawings, in which:

### BRIEF DESCRIPTION OF THE DRAWINGS

FIG. 1 is a schematic view of an apparatus with a digital camera module for real-time monitoring of a workpiece according to a preferred embodiment of the present invention, together with a workpiece; and

FIG. 2 is a schematic, side cut-away view of the digital camera module of the apparatus of FIG. 1.

### DETAILED DESCRIPTION OF PREFERRED EMBODIMENTS

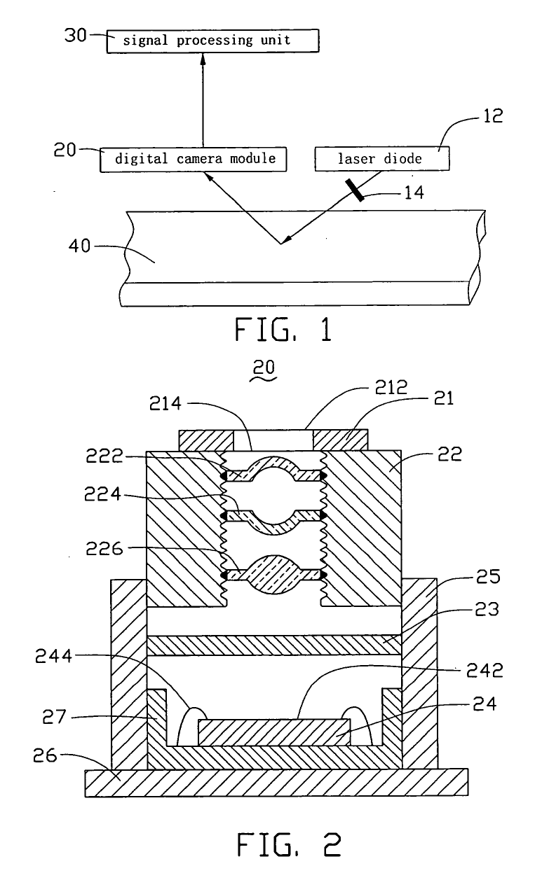

FIG. 1 schematically shows an apparatus for real-time monitoring of a workpiece, according to a preferred embodiment of the present invention. The apparatus for real-time monitoring is typically used to detect a workpiece 40, to determine whether there are any defects or flaws in the workpiece 40. In this embodiment, the apparatus for real-time monitoring includes a laser diode 12 as a light source, a polarization rotator 14, a digital camera module 20 as an image pickup module, and a signal processing unit 30. The polarization rotator 14 is disposed in the light path of the laser diode 12 above the workpiece 40, and provides polarized light at selected angles. The laser diode 12 emits a light, which is polarized by the polarization rotator 14 and then is incident upon the workpiece 40. The polarized light is reflected by the workpiece 40 to form a reflected light. The reflected light is picked up by the digital camera module 20, which forms an optical image signal of a portion of the workpiece 40 which is irradiated by the light. The optical image signal is then transformed into an electrical image signal in the digital camera module 20.

The laser diode 12 may emit light having a wavelength in the range of 400□1700 nm; and preferably 650 nm, 405 nm or shorter than the wavelength of blue light. The laser diode 12 has high output power. In addition, the laser diode 12 possesses high radiance, because an emitting area of the laser diode 12 is small and can be modulated (turned off and on) at high speeds.

Referring to FIG. 2, the digital camera module 20 typically includes a cover 21, a barrel 22 serving as a lens receiver, a first lens 222, a second lens 224, a third lens 226, a glass plate 23, an image pick-up sensor 24 and a holder 25. The image pick-up sensor 24 typically includes an imaging surface 242, and is packaged on a Flexible Printed Circuit (FPC) Board 26 via a Ceramic Leaded Chip Carrier (CLCC) 27. A bottom part of the barrel 22 is inserted into and engaged in a top part of the holder 25. The first lens 222, the second lens 224, and the third lens 226 are all contained in the barrel 22.

The cover 21 may be circular, and is fixed on a top of the barrel 22. The cover 21 defines two opposite central openings 212, 214 at two opposite top and bottom sides thereof respectively. Therefore incident lights can penetrate the cover 21, transmit to the first lens 222, transmit to the second lens 224, and lastly transmit to the third lens 226. A proofing lens (not shown) can also be provided between the opening 212 and the opening 214, to protect the digital camera module 20 against dust and contamination.

The first lens 222, the second lens 224 and the third lens 226 are typically used to focus the incident light. Peripheral portions of the first lens 222, the second lens 224 and the third lens 226 are fixed in respective indented portions of an inner surface of the barrel 22 by an adhesive. The peripheral portions of the first, second and third lenses 222, 224, 226 are significantly smaller in area than the respective overall sizes thereof

The first lens 222 has a meniscus central portion, which defines two opposite top and bottom aspheric surfaces (not labeled) respectively. The bottom surface of the first lens 222 is concave. The first lens 222 is made of glass, so that it can resist dampness, high temperatures, and abrasion. The second lens 224 is similar in shape but disposed symmetrically opposite to the first lens 222. The second lens 224 is made of glass or optical plastic, which can be acrylic resin, polymethyl methacrylate (PMMA), or polycarbonate (PC). The third lens 226 has two outwardly protruding sub-hemispherical central portions, which define two opposite top and bottom aspheric surfaces (not labeled) respectively. That is, the third lens 226 is a biconvex, aspheric lens with the two aspheric surfaces (not shown). The third lens 226 is made of glass.

Additionally, an AR-Coating (antireflective coating) can be provided on at least one of the aspheric surfaces of the first lens 222. The AR-Coating is typically a thin film that includes alternately stacked layers of silicon dioxide (SiO2) and tantalum pentoxide (Ta2O5). Therefore, the light transmittance ratio of the first lens 222 is increased, and the reflectivity of the first lens 222 is decreased. Furthermore, an IR-Cut Coating can be provided on at least one of the aspheric surfaces of the third lens 226. The IR-Cut (Infrared-Cut) Coating is typically a film that can prevent incident infrared light rays from reaching the image pick-up sensor 24.

The glass plate 23 is contained and fixed in the holder 25 between the barrel 22 and the image pick-up sensor 24, and is for protecting the imaging surface 242 of the image pick-up sensor 24. The image pick-up sensor 24 can be a Complementary Metal-Oxide Semiconductor (CMOS) type sensor or a Charge Coupled Device (CCD). A plurality of wires 244 connects the image pick-up sensor 24 with the CLCC 27, which in turn is adapted to be electrically connected with the FPC 26. The image pick-up sensor 24 can thus convey electrical signals to the FPC 26. The holder 25 is a hollow cylinder, and defines two opposite top and bottom openings (not labeled). The top opening has the bottom part of the barrel 22 engaged therein, and the bottom opening has the image pick-up sensor 24 and the CLCC 27 received therein.

In assembly, the glass plate 23 is inserted into and fixed in the holder 25. The image pick-up sensor 24 attached on the CLCC 27 is inserted into the holder 25 through the bottom opening thereof, and is fixed in the holder 25. The first lens 222, the second lens 224, and the third lens 226 are inserted into and fixed in the barrel 22. The bottom part of the barrel 22 is inserted into and engaged in the top part of the holder 25. Finally, the cover 21 is fixed on the top of the barrel 22. The structure of the digital camera module 20 of the preferred embodiment can effectively protect the first lens 222, the second lenses 224 and the third lens 226 thereof from moisture, dampness, and oxidation.

The signal processing unit 30 is respectively electrically connected with the digital camera module 20 and the laser diode 12 to control the operation of the laser diode 12. The signal processing unit 30 analyzes and determines whether there are any flaw or defects in the workpiece 40 according to the image signal picked up by the digital camera module 20. The signal processing unit 30 can be a 32/64 bit computer which can analyze and process data information.

In use, firstly, the laser diode 12 and the digital camera module 20 are adjusted to proper positions according to the general surface properties of the workpiece 40. Simultaneously, the angle between the digital camera 20 and the workpiece 40 is adjusted to a correct angle along an incident direction. The laser diode 20 is turned on such that the laser diode 20 emits a laser light, which is polarized by the polarization rotator 14 and then is incident upon the workpiece 40. The laser light is reflected by the workpiece 40 to form a reflective light signal which is picked up by the digital camera module 20 along a reflective pickup direciton. That is, the digital camera module 20 picks up a portion of the workpiece 40 radiated by the light to form an optical image signal of that portion of the workpiece 40. The optical image signal is transformed into an electrical image signal via the image pick-up sensor 24 in the digital module 20. Then the electrical image signal is transmitted to the signal processing unit 30, and is transformed into a digital image signal via an analog to digital conversion circuit in the signal processing unit 30. Then, the signal processing unit 30 analyzes the digital image signal to determine whether there are any defects or flaws in the current state of the workpiece 40.

In summary, a main advantage of the invention is that the volume of the apparatus for real-time monitoring is reduced because a conventional CCD video is replaced by a digital camera module. Accordingly, the space required in an application such as a production line is reduced. In addition, the monitoring efficiency is improved because of the application of a laser diode. Furthermore, the digital camera module adopts aspheric lenses. Therefore the quality of imaging of the workpiece is improved, which improves the quality of monitoring.

The apparatus for real-time monitoring can be used not only to detect defects or flaws of workpieces, but also in fields such as precision machining, surface treatment, electronic packaging, and semiconductor manufacturing.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An apparatus for real-time monitoring of a workpiece, comprising:
a laser diode for emitting a light irradiating the workpiece;
a digital camera module for imaging the workpiece, forming an optical image signal, and transforming the optical image signal into an electrical image signal; and
a signal processing unit electrically connected with the laser diode and the digital camera module, for processing the electrical image signal and determining whether there is any defect or flaw in the workpiece.

2. The apparatus as claimed in claim 1, wherein the digital camera module comprises a barrel, a first lens and an image pick-up sensor, and the first lens is aspheric and received in the barrel.

3. The apparatus as claimed in claim 2, wherein the digital camera module further comprises a second lens and a third lens, and the second and third lenses are aspheric.

4. The apparatus as claimed in claim 3, wherein the first lens and third lens are made of glass material.

5. The apparatus as claimed in claim 2, wherein an AR-Coating is provided on a surface of the first lens.

6. The apparatus as claimed in claim 3, wherein an AR-Coating is provided on a surface of the first lens.

7. The apparatus as claimed in claim 4, wherein an AR-Coating is provided on a surface of the first lens.

8. The apparatus as claimed in claim 5, wherein the AR-Coating comprises alternately stacked layers of silicon dioxide and tantalum pentoxide.

9. The apparatus as claimed in claim 6, wherein the AR-Coating comprises alternately stacked layers of silicon dioxide and tantalum pentoxide.

10. The apparatus as claimed in claim 7, wherein the AR-Coating comprises alternately stacked layers of silicon dioxide and tantalum pentoxide.

11. The apparatus as claimed in claim 3, wherein an IR-Cut coating is provided on a surface of the third lens.

12. The apparatus as claimed in claim 4, wherein an IR-Cut coating is provided on a surface of the third lens.

13. The apparatus as claimed in claim 2, wherein the digital camera module further comprises a holder receiving the image pick-up sensor and at least partly receiving the barrel.

14. The apparatus as claimed in claim 13, wherein the digital camera module still further comprises a glass plate fixed in the holder between the barrel and the image pick-up sensor.

15. The apparatus as claimed in claim 2, wherein the image pick-up sensor comprises a charge coupled device.

16. The apparatus as claimed in claim 2, wherein the image pick-up sensor comprises a Complementary Metal-Oxide Semiconductor.

17. A method for real-time monitoring of a workpiece, comprising the steps of:
equipping with a light source facing said workpiece;
equipping with an image pickup module having at least one aspheric lens and modularized semiconductor image pickup sensor;
adjusting an incident direction of said light source to said workpiece and a reflective pickup direction of said image pickup module relative to said workpiece; and
actuating said light source to release lights onto said workpiece so as to acquire images of said workpiece for said monitoring by reflective-light-pickup of said module.

18. The method as claimed in claim 17, wherein said image pickup module comprises two aspheric lenses as for said at least one aspheric lens, said two aspheric lenses are glass-made and disposed to face said workpiece and said image pickup sensor of said image pickup module respectively.

19. The method as claimed in claim 17, wherein said light source is a laser diode.

20. A method for real-time monitoring of a workpiece, comprising the steps of:
providing laser lights toward said workpiece from a laser light source;
acquiring images of said workpiece by receiving reflective lights of said laser lights from said workpiece via an image pickup module; and
identifying a current state of said workpiece by means of analyzing said images of said workpiece.
